(19) United States
(12) Patent Application Publication
(10) Pub. No.: US 2022/0009809 A1
(43) Pub. Date: Jan. 13, 2022

(54) DEGRADATION OF RECALCITRANT ORGANIC POLLUTANTS

(71) Applicant: Feng Xiao, (US)

(72) Inventor: Feng Xiao, Grand Forks, ND (US)

(73) Assignee: The University of North Dakota, Grand Forks, ND (US)

(21) Appl. No.: 16/923,637

(22) Filed: Jul. 8, 2020

(51) Int. Cl. C02F 9/00

(52) U.S. Cl. CPC C02F 9/00; C02F 2101/306; C02F 2303/16

(57) ABSTRACT

A method for removing recalcitrant organic compounds from water includes exposing water to an oxidizing agent, thereby reducing an amount of at least some classes of dissolved organic matter in the water and adsorbing at least some of the remaining dissolved organic matter in the water onto a porous adsorbent, resulting in adsorbed organic matter on the porous adsorbent. The method includes thermally treating the adsorbed organic matter on the porous adsorbent to remove and degrade the adsorbed organic matter.

### BACKGROUND

The present invention relates generally to the degradation of recalcitrant organic compounds. More particularly, the invention relates to methods for reducing an amount of fluorinated compounds in a contaminated water source.

Poly- and perfluoroalkyl substances (PFAS) are a large group of organic compounds that have been mass-produced since the 1950s for a variety of products and processes, including aqueous film-forming foams (AFFFs) and many consumer goods. Groundwater contamination by PFAS is directly associated with surface soil contamination. The major contamination sources include fire-training sites using AFFFs and municipal solid waste landfills. Concentrations of PFOA/PFOS as high as 87,140 ng/L have been measured in landfill leachates. PFAS can move off-site from contamination sources (landfills, AFFF-applied sites, or biosolids) and migrate to aquifers by leaching through the soil and surface waters by water runoff. The off-site migration of PFAS may be a threat to communities in proximity to PFAS contamination sources.

Once released to the natural environment, long-chain PFAS (≥7 perfluorocarbons) may bioaccumulate and biomagnify in the environment through natural food webs. Some PFAS are subject to chemical and biological degradation, while others including perfluoroalkyl acids (PFAAs) are chemically and biologically recalcitrant. PFAAs have been frequently detected in the environment. In particular, two eight-carbon PFAA compounds, perfluorooctanoic acid (PFOA) and perfluorooctanesulfonic acid (PFOS), have been observed in >95% of the blood samples collected during multiple U.S. national surveys at health-relevant concentrations. The U.S. EPA has recently set a drinking water advisory on the combined level of PFOA and PFOS at 0.070 μg/L, making removal of PFOA/PFOS from drinking water and remediation of PFAS-contaminated sites a priority issue.

### SUMMARY

A method for removing recalcitrant organic compounds from water includes exposing water to an oxidizing agent, thereby reducing an amount of at least some classes of dissolved organic matter in the water and adsorbing at least some of the remaining dissolved organic matter in the water onto a porous adsorbent, resulting in adsorbed organic matter on the porous adsorbent. The method includes thermally treating the adsorbed organic matter on the porous adsorbent to remove and degrade the adsorbed organic matter including PFAS.

A method for removing recalcitrant organic compounds from water includes treating water by coagulation, flocculation, sedimentation, or filtration to remove suspended or colloidal particles from the water and exposing the water to an oxidizing agent, thereby reducing an amount of at least some classes of dissolved organic matter in the water. The method includes adsorbing at least some of the remaining dissolved organic matter in the water onto a porous adsorbent resulting in adsorbed organic matter on the adsorbent. The adsorbed organic matter includes a compound selected from the group consisting of anionic PFAS, cationic PFAS, zwitterionic PFAS, and nonionic PFAS. The adsorbed organic matter includes a compound selected from persistent organic pollutants, herbicides, pesticides, pharmaceuticals, personal care products, hormones, industrial organic chemicals, and combinations thereof. The method includes thermally treating the adsorbed organic matter on the adsorbent to remove and degrade the adsorbed organic matter.

### BRIEF DESCRIPTION OF THE DRAWINGS

FIG. 1 is a process for treating contaminated water.

FIG. 2 is one embodiment of a process for treating water from soil leachate, landfill leachate, groundwater, wastewater treatment facility, or other PFAS-contaminated water source to remove recalcitrant organic compounds.

FIGS. 3A-3C are thermal gravimetric analysis (TGA) plots of various PFAS.

FIG. 3D is a plot of T50 versus the number of perfluorinated carbons in PFAS.

FIGS. 3E and 3F are Arrhenius-like and Eyring-like plots of PFOA and PFOS, respectively.

FIGS. 4A-4L are decomposition plots of PFAS bound to granulated activated carbon (GAC).

FIGS. 5A and 5B are thermal degradation plots of PFOA and PFOS, respectively.

FIGS. 6A-6I are a series of mass chromatograms showing the amount of PFOA is decreased as temperature is increased.

### DETAILED DESCRIPTION

Many PFAS such as, for example, PFOA and PFOS are not easily removed from water using conventional drinking water treatment processes. Accordingly, for purposes of this application, these PFAS will be described as one group of recalcitrant organic compounds. For example, coagulation and flocculation processes achieve only up to 25% of PFOA and PFOS removal. Both chemicals (PFOA and PFOS) are recalcitrant to degradation because of the strong carbon-fluorine bond.

Various chemical and physical approaches have been tested to remove PFAS from water. This invention discloses oxidation by ozonation or advanced oxidation processes of water to reduce the amount of dissolved organic matter (DOM), adsorption of PFAS on porous adsorbents such as granular activated carbon, and thermal decomposition of PFAS on adsorbents by thermal treatment above 200° C. with or without catalysts.

The system may also include coagulation, flocculation, sedimentation/flotation, filtration, and disinfection to remove suspended or colloidal particles and pathogens.

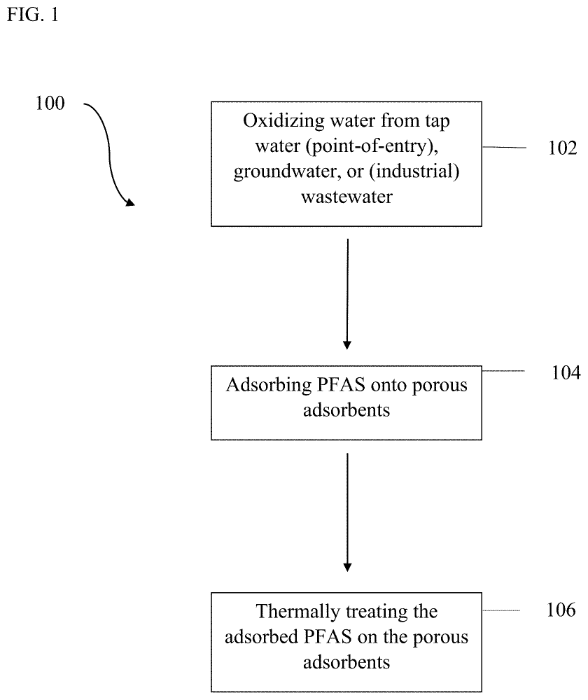

FIG. 1 is a process for treating contaminated water. FIG. 1 shows process 100 including steps 102, 104, and 106. Major sources of contaminated water containing recalcitrant organic compounds are sourced from, for example, soil leachate, landfill leachate, groundwater, or wastewater treatment facilities.

Step 102 of process 100 uses an oxidant such as, for example, ozone to breakdown organic molecules present in water such as tap water (point-of-entry), groundwater containing a limited amount of suspended or colloidal particles, or (industrial) wastewater.

While PFAAs are stable during oxidation, including ozonation, PFAA precursor compounds such as polyfluoroalkyl amides and polyfluoroalkyl sulfonamides can be quickly converted into PFAAs by oxidants such as described in “PFOA and PFOS Are Generated from Zwitterionic and Cationic Precursor Compounds During Water Disinfection with Chlorine or Ozone” Environmental Science & Technology Letters, 5, pp. 382-388, 2018 by XIAO, F., HANSON, R., GOLOVKO, S. A., GOLOVKO, M. Y., ARNOLD, W. A., The half-lives of precursor compounds of PFAAs can be shorter than 10 min during ozonation. Furthermore, fluorotelomer unsaturated carboxylic acids can be converted after 20 min of ozonation to PFAAs. Ozonation or advanced oxidation is also an effective treatment for inactivation of pathogens and removal of DOM and many xenobiotic organic compounds that may otherwise compete with PFAS for adsorption on adsorbents such as GAC. In other words, the oxidation treatment step can reduce the amount of available organic compounds that may preferentially adsorb on GAC compared to PFAS. As such, more PFAS is bound to GAC in the presence of other organic compounds with an oxidation pre-treatment step compared to a system without using an oxidation pre-treatment step.

Step 104 of process 100 adsorbs PFAS onto porous adsorbents, which can be, for example, GAC (granular activated carbon) or anion exchange capacity (AEC)-enhanced GAC. AEC-enhanced GAC can be made by incorporating strong anion exchange functional groups onto GAC such as, for example, amine groups.

In one example, AEC-enhanced GAC can be formed from a biomass material such as, for example, peanut shells or corn cobs, which are dried in a drying oven, ground in a blender, and sieved. Peanut shell particles are mixed with nitrogen-rich chemicals such as, for example, cetrimonium chloride or melamine and pyrolyzed in a dual zone tube furnace. The resultant char can be activated in the same furnace. The AEC-enhanced GAC is then washed with deionized water and dried.

In a second example, GAC is mixed with nitrogen-rich chemicals and pyrolyzed. The resultant AEC-enhanced GAC is washed with deionized water and dried.

In a third example, GAC is heated in an atmosphere of NH₃, forming AEC-enhanced GAC.

The oxidized water samples can be passed through a column containing porous adsorbents such as GAC or AEC-enhanced GAC. The effluent of the column can optionally be disinfected by chlorination to inactivate pathogens. Aliquots of solution can be taken before and after each of the treatment units and microfiltered (0.45 μm) to HPLC vials for determination of PFAS concentrations.

Step 106 of process 100 thermally treats adsorbed PFAS on adsorbents such as GAC. The heat treatment step decomposes bound PFAS from GAC. As such, GAC is thermally regenerated and can be reused to bind more PFAS from the water source following regeneration. Furthermore, the adsorbed PFAS can be thermally degraded to fluoride ions and liberated from GAC, provided sufficient temperatures are used. Thermally degrading PFAS beneficially prevents PFAS from re-entering the environment and obviates the need for long term storage of these recalcitrant organic molecules.

In one embodiment, the temperature for effectively removing perfluoroalkyl carboxylic acids (PFCAs) and perfluoroalkyl ether carboxylic aids (PFECA) on adsorbent (e.g., GAC) should be 150° C. or higher for at least 5 min with or without catalysts. In one embodiment, the temperature for effectively removing perfluoroalkyl carboxylic acids (PFCAs) and perfluoroalkyl ether carboxylic aids (PFECA) on an adsorbent (e.g., GAC) is from 650° C. to 1300° C. for at least 5 min with or without catalysts to achieve 50 mol % or more mineralization of fluoride ions (F⁻). In one embodiment, the temperature for effectively removing perfluoroalkyl carboxylic acids (PFCAs) and perfluoroalkyl ether carboxylic aids (PFECA) on an adsorbent (e.g., GAC) is from 700° C. to 1300° C. for at least 5 min with or without catalysts to achieve 90 mol % or more mineralization of fluoride ions (F⁻).

In one embodiment, the temperature for effectively removing perfluoroalkyl sulfonic acids (PFSAs) on adsorbent (e.g., GAC) should be 400° C. or higher for at least 5 min with or without catalysts. In one embodiment, the temperature for effectively removing perfluoroalkyl sulfonic acids (PFSAs) on adsorbent (e.g., GAC) is between 600° C. and 1300° C. for at least 5 min with or without catalysts to achieve 50 mol % or more mineralization of fluoride ions (F⁻). In one embodiment, the temperature for effectively removing perfluoroalkyl sulfonic acids (PFSAs) on adsorbent (e.g., GAC) is between 800° C. and 1300° C. for at least 5 min with or without catalysts to achieve 85 mol % or more mineralization of fluoride ions (F⁻).

The thermal treatment of PFAS-laden adsorbent (e.g., GAC) in the atmosphere of N₂ or CO₂ can be performed at 150-1300° C. for up to 240 min with or without catalysts.

The thermal treatment of PFAS-laden adsorbent (e.g., GAC) in the atmosphere of air of oxygen can be performed at 150-550° C. for up to 60 min with or without catalysts.

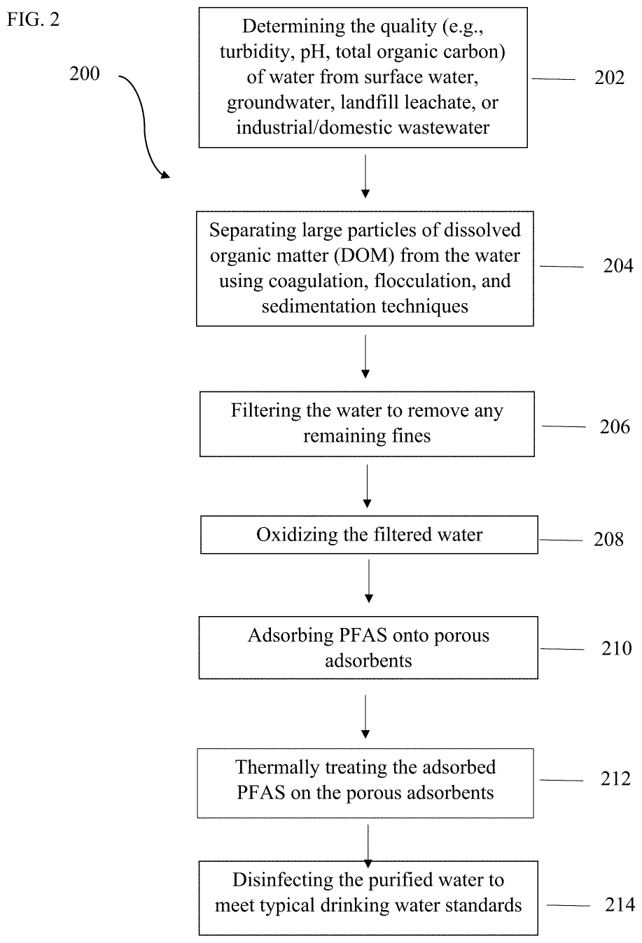

FIG. 2 is one embodiment of a process for treating water from soil leachate, landfill leachate, groundwater, wastewater treatment facility, or other PFAS contaminated water source to remove recalcitrant organic molecules. FIG. 2 shows process 200 including steps 202, 204, 206, 208, 210, 212, and 214.

Process 200 begins by determining the quality (e.g., turbidity, pH, total organic carbon) of the source water, which can be for example surface water, groundwater, landfill leachate, or industrial or domestic wastewater (step 202). While steps 208, 210, and 212 are substantially the same as described for respective steps 102, 104, and 106 of process 100, steps 204, 206, and 214 are optional or can be performed in a different order than shown in FIG. 2. For example, landfill leachates and upstream sources from a wastewater treatment facility typically have relatively high levels of colloidal particles and dissolved organic matter (DOM) that may interfere with the adsorption of PFAS on adsorbents such as GAC. Coagulation, flocculation, and sedimentation techniques known in the art can be used to remove the colloidal particles and DOM. However, groundwater can have relatively low levels of DOM and turbidity compared to landfill leachates and water from upstream sources in a wastewater treatment facility. As such, coagulation, flocculation, and sedimentation techniques can be optimized and applied before the removal of PFAS from the water or not performed at all if the turbidity and DOM levels meet required standards. In one example, ferric chloride can be more effective in removing DOM and turbidity from landfill leachates compared to alum.

Step 204 uses coagulation, flocculation, and sedimentation techniques to remove colloidal particles and DOM from water sources. For example, landfill leachates and influent streams at wastewater treatment facilities have relatively high levels of DOM. Coagulation, flocculation, and sedimentation are efficient pretreatments for removing DOM, colloidal particles, and heavy metals. Some wastewater treatment facilities can have multiple steps using coagulation, flocculation, and sedimentation techniques to process influent streams to make them suitable for drinking water. However, step 204 may be unnecessary if the water source is not turbid and already has low levels of DOM. Alternatively, step 204 can be performed after PFAA has been removed from the water.

Step 206 filters the water to remove fines that may be present in the water. Many water sources contain fines, even after using coagulation, flocculation, and sedimentation techniques. As such, a filtering step through sand or other filtration medium can help to remove the fines. Other know filtration media such as paper, sand, dirt, gravel, or other filtration media can be used to remove fines from the water.

Step 208 of process 200 is substantially the same as step 102 of process 100 and uses an oxidizing agent such as ozone to breakdown organic molecules present in a water source such as, for example, groundwater, landfill leachate, soil leachate, and wastewater treatment facilities.

Step 210 of process 200 is substantially the same as step 104 of process 100 and adsorbs PFAS onto adsorbents such as GAC.

Step 212 of process 200 is substantially the same as step 106 of process 100 and thermally treats the adsorbent such as GAC containing adsorbed PFAS.

Step 214 disinfects the purified water to meet typical drinking water or wastewater standards. Many localities require active disinfection throughout the delivery system to the point of delivery for drinking water. For example, adding chlorine to the water provides disinfection capabilities throughout the transit system until it is delivered to a user.

### Examples

Surface water samples were collected from the Red River near Grand Forks, N.D. Individual and multiple PFAS from Table 1 were spiked into water samples at a concentration of 1 μmol/L and were equilibrated for 48 hours at room temperature (˜22° C.). Spiked PFAS included one or more of the following: perfluoroalkyl carboxylic acids (PFCA); perfluoroalkyl sulfonic acids (PFSA); perfluorobutanoic acid (PFBA); the acid form of GenX (HFPO-DA); N-ethyl perfluorooctane sulfonamide acetate acid (N-Et-FOSSA); fluorotelomer alcohol (FTOH); perfluorooctaneamido ammonium salt (PFOAAmS); perfluorooctanesulfonamido ammonium salt (PFOSAmS); perfluorooctaneamido betaine (PFOAB); perfluorooctanesulfonamido betaine (PFOSB).

TABLE 1
PFAS chemicals used in the example study

| | Acronyms | Purity | Providers |
|---|---|---|---|
| PFCAs | | | |
| Perfluorobutyric acid (C4) | PFBA | ≥99.5 | Sigma-Aldrich |
| perfluoropentanoic acid (C5) | PFPeA | 97% | Sigma-Aldrich |
| Perfluoroheptanoic acid (C6) | PFHpA | ≥98% | Fisher |
| | | | Scientific |
| Perfluorooctanoic acid (C8) | PFOA | 95% | Sigma-Aldrich |
| Perfluorononanoic acid (C9) | PFNA | 97% | Sigma-Aldrich |
| Perfluorodecanoic acid (C10) | PFDA | 98% | Sigma-Aldrich |
| perfluoroundecanoic acid | PFUnDA | 95% | Sigma-Aldrich |
| (C11) | | | |
| PFSAs | | | |
| Perfluorobutanesulfonic acid | PFBS | 98.0% | Sigma-Aldrich |
| potassium salt (C4) | | | |
| Perfluorohexanesulfonic acid | PFHxS | ≥98.0% | Sigma-Aldrich |
| potassium salt (C6) | | | |
| Perfluorooctanesulfonic acid | PFOS | ≥98.0% | Sigma-Aldrich |
| potassium salt (C8) | | | |
| PFECA | | | |
| (perfluoroalkyl ether | | | |
| carboxylic acid) | | | |
| 2,3,3,3-tetrafluoro-2- | HFPO-DA | 97% | Fisher |
| (1,1,2,2,3,3,3- | (GenX) | | Scientific |
| heptafluoropropoxy)propanoic | | | |
| acid (C3) | | | |

Spiked samples underwent coagulation with alum (Al₂(SO₄)₃.18H₂O) at a dose of 40 mg/L, 20-min flocculation, and 30-min settling, followed by filtration through a Whatman paper filter (Grade 5) to remove remaining fine particles/flocs. Ozonation was then carried out at a dose of 3.6 mg/L for 60 min.

Three different AEC-enhanced GAC samples were formed. In one example, a biomass material made from peanut shells was dried in a drying oven (Cascade Tek, Cornelius, Oreg.) at 70° C., ground in a blender, and sieved. Peanut shell particles between 0.4 and 2 mm were mixed with a nitrogen-rich chemical and pyrolyzed in a dual zone tube furnace (MTI Corporation, CA) under a flow of N₂ at 300-700° C. The resultant char was activated in the same furnace at ≥700° C. under a flow of CO₂. The GAC was washed with deionized water and dried at 103° C.

In a second example, a commercial GAC was mixed with a nitrogen-rich chemical and the mixture was pyrolyzed at 300-700° C. and then at ≥700° C. The resultant AEC-enhanced GAC was washed with deionized water and dried at 103° C. Elemental analysis indicated both approaches generated nitrogen-rich GAC.

In a third example, a commercial GAC or a biomass material was heated in an atmosphere of NH₃ to induce the formation of nitrogen-containing functional groups on the surface of GAC.

The PFAS-laden GAC was divided into two substantially equal portions. The first portion was freeze-dried, weighed, and extracted using methanol with 100 mmol/L ammonium acetate (NH₄Ac) and used to determine the amount of PFAS adsorbed before thermal treatment. The second portion of spent GAC was transferred to a porcelain crucible and heated in a temperature-programmable two-zone quartz tube furnace (MTI Corporation, CA) and regenerated by thermal treatment under a flow of, N₂, CO₂, or air. The sample was heated at the rate of 10° C./min to the desired final heat treatment temperature (HTT=room temperature (non-heating control) up to 900° C.) and held for 30 min. Off-gas from the furnace was passed through a series of seven beakers containing free fluorine ions (F⁻) in deionized water (DW) (#1-6) or in methanol (#7). After the thermal treatment and cool down, the crucible was placed in a known volume of DW (#8) and ultrasonicated for 30 min. Concentrations of F⁻ in DW samples and residual PFAS in DW and methanol samples were determined and their mass were calculated. Concentrations of F⁻ were determined by USEPA SPADNS Method 8029.

Thermal treatment of the GAC effectively decomposed adsorbed PFAS. In sum, the levels of PFAS on the carbon before and after regeneration were determined. The thermally treated GAC was regenerated and can be reused to adsorb PFAA from additional water sources containing PFAS.

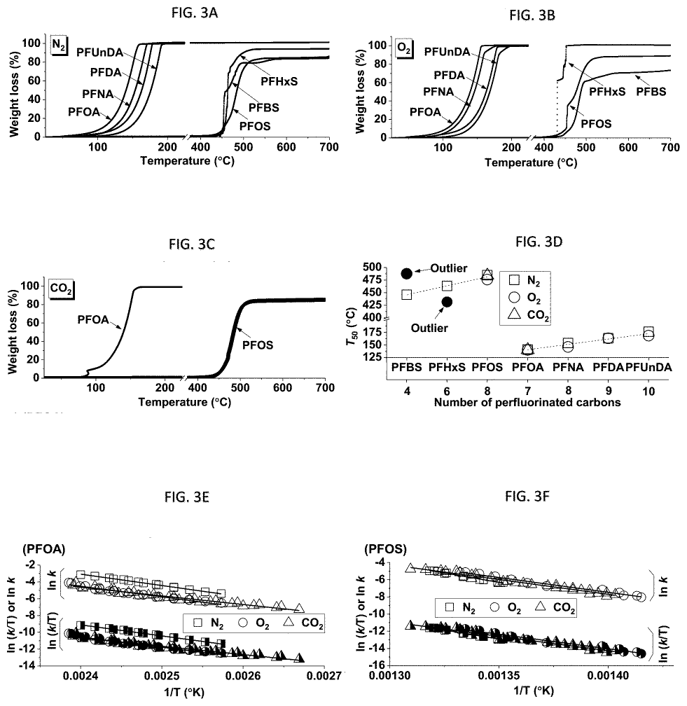

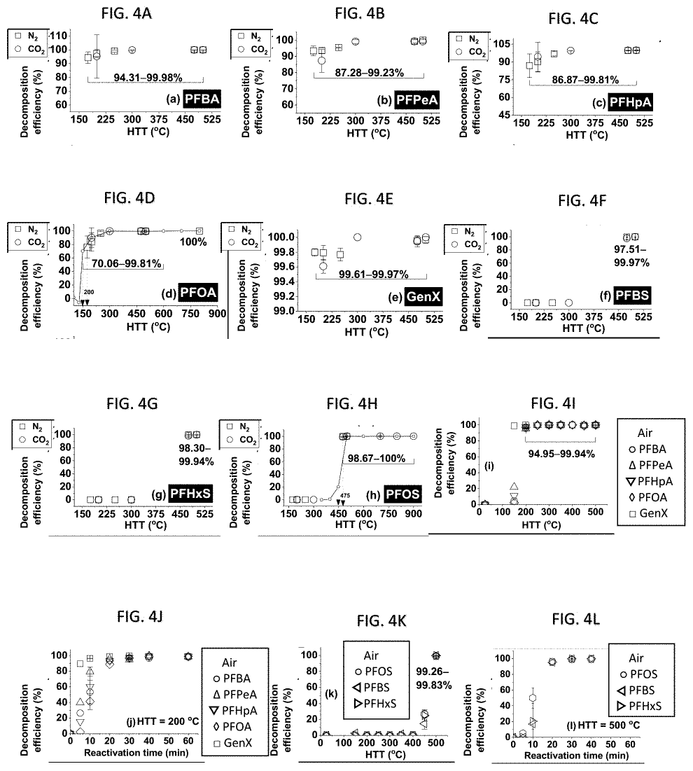

FIGS. 3A-3C are thermal gravimetric analysis (TGA) plots of various PFAS. FIGS. 3A-3C show the percent weight loss (thermal breakdown) for various PFAS as a function of temperature in different atmospheres, N₂, O₂, and CO₂, respectfully. FIG. 3D is a plot of the T50 versus the number of perfluorinated carbons in PFAS. FIG. 3D shows that the T50 temperature increases as the number of perfluorinated carbons increase. FIGS. 3E and 3F are Arrhenius-like (ln k vs 1/T) and Eyring-like (ln k/T vs 1/T) plots of PFOA and PFOS, respectfully. FIGS. 4A-4L are decomposition plots of PFAS adsorbed on GAC. FIGS. 4A-4L show the thermal reactivation of the GAC performed in a tube furnace for 30 minutes under a flow of N₂, CO₂, or air in a closed system.

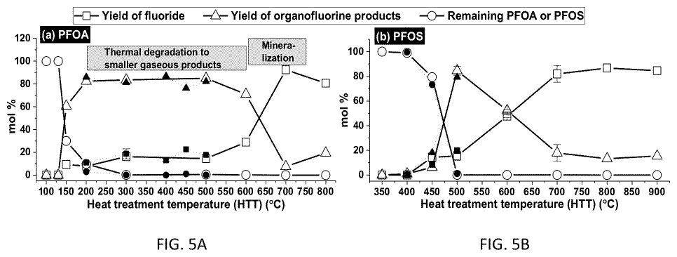

FIGS. 5A and 5B are thermal degradation plots of PFOA and PFOS, respectively. FIGS. 5A and 5B show the mineralization of PFOA and PFOS to fluoride ions (F⁻) occurs at higher temperatures.

As shown in FIGS. 5A and 5B, measured yields of F⁻ indicated significant mineralization of PFOA or PFOS loaded on GAC at an HTT of ≥700-800° C. For example, the mineralization rate of PFOA loaded on GAC increased to 92 mol % at 700° C. from 9-29 mol % at 150-600° C. Similarly, the yield of F⁻ from PFOS loaded on GAC gradually increased with HTT, reaching a value of 87 mol % at 800° C. The mineralization rate in N₂ was not significantly different from that in air at a given HTT.

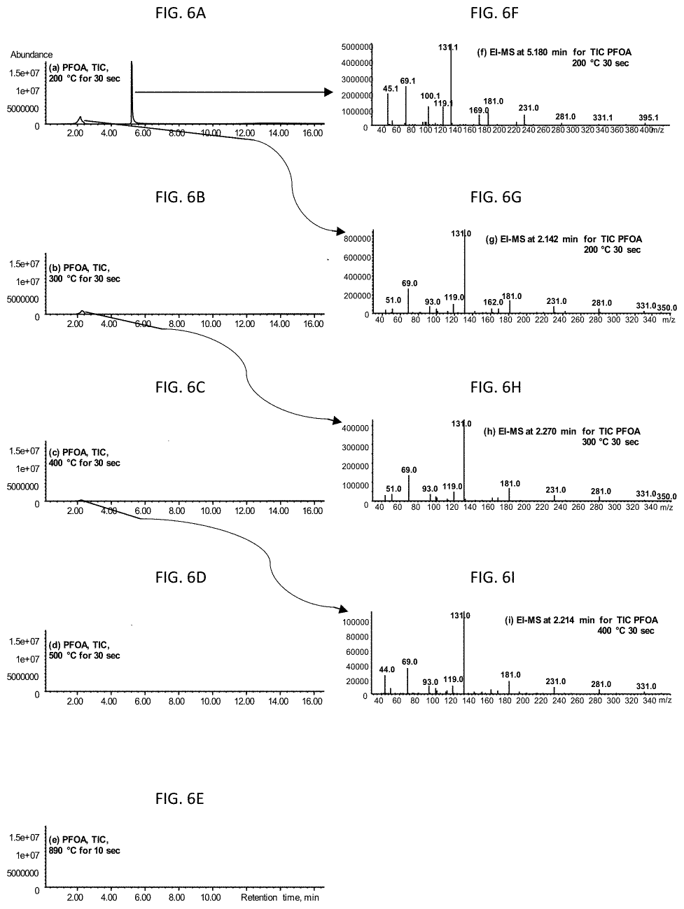

FIGS. 6A-6I are a series of mass chromatograms showing the amount of PFOA is decreased as temperature is increased.

The biodegradation, ozonation, or chlorination products of precursor compounds were identified by time-of-flight mass spectrometry.

PFAS such as PFOA and PFOS are not easily removed from water using conventional drinking water treatment processes. However, using (AEC-enhanced) GAC for removal of PFAS from various water sources can remove more than 90% of PFAS contaminants. Thermal treatment of the PFAS-laden GAC effectively removes and decomposes PFAS contaminants. The GAC can be regenerated and reused in a cyclical manner. As such, PFAS is effectively degraded using the disclosed methods and does not re-enter the environment or require storage.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for removing recalcitrant organic compounds from water, the method comprising:
exposing water to an oxidizing agent, thereby reducing an amount of at least some classes of dissolved organic matter in the water;
adsorbing at least some of the remaining dissolved organic matter in the water onto a porous adsorbent, resulting in adsorbed organic matter on the porous adsorbent; and
thermally treating the adsorbed organic matter on the porous adsorbent to remove and degrade the adsorbed organic matter.

2. The method of claim 1, wherein the adsorbed organic matter includes a compound selected from the group consisting of persistent organic pollutants, herbicides, pesticides, pharmaceuticals, personal care products, hormones, industrial organic chemicals, and combinations thereof.

3. The method of claim 2, wherein the adsorbed organic matter includes a compound selected from the group consisting of anionic PFAS, cationic PFAS, zwitterionic PFAS, and nonionic PFAS.

4. The method of claim 3, wherein the adsorbed organic matter includes a compound selected from the group consisting of PFBA, PFPeA, PFHpA, PFOA, PFNA, PFDA, PFUnDA, HFPO-DA, PFBS, PFHxS, PFOS, and combinations thereof.

5. The method of claim 1, wherein the porous adsorbent is GAC, biochar, resins, or polymers.

6. The method of claim 1, wherein the porous adsorbent is GAC.

7. The method of claim 4, wherein the adsorbed organic compounds include PFOA and thermally treating is performed at a temperature from 150° C. to 1300° C., inclusive.

8. The method of claim 7, wherein the amount of PFOA mineralized to fluoride ions (F⁻) is from 10 to 100 mol %.

9. The method of claim 8, wherein the amount of PFOA mineralized to fluoride ions (F⁻) is from 50 to 100 mol %.

10. The method of claim 4, wherein the adsorbed organic compounds include PFOS and thermally treating is performed at a temperature from 400° C. to 1300° C., inclusive.

11. The method of claim 10, wherein the amount of PFOS mineralized to fluoride ions (F⁻) is from is from 10 to 100 mol %, inclusive.

12. The method of claim 11, wherein the amount of PFOS mineralized to fluoride ions (F⁻) is from is from 50 to 100 mol %, inclusive.

13. A method for removing recalcitrant organic compounds from water, the method comprising:
treating water by coagulation, flocculation, sedimentation, or filtration to remove suspended or colloidal particles from the water;
exposing the water to an oxidizing agent, thereby reducing an amount of at least some classes of dissolved organic matter in the water;
adsorbing at least some of the remaining dissolved organic matter in the water onto a porous adsorbent resulting in adsorbed organic matter on the adsorbent, wherein the porous adsorbent is GAC and wherein the adsorbed organic matter includes a compound selected from the group consisting of anionic PFAS, cationic PFAS, zwitterionic PFAS, nonionic PFAS, persistent organic pollutants, herbicides, pesticides, pharmaceuticals, personal care products, hormones, industrial organic chemicals, and combinations thereof; and
thermally treating the adsorbed organic matter on the adsorbent to remove and degrade the adsorbed organic matter.

14. The method of claim 13, wherein the adsorbed organic matter includes a compound selected from the group consisting of PFBA, PFPeA, PFHpA, PFOA, PFNA, PFDA, PFUnDA, HFPO-DA, PFBS, PFHxS, PFOS, and combinations thereof.

15. The method of claim 14, wherein the adsorbed organic compounds include PFOA and thermally treating is performed at a temperature from 150° C. to 1300° C., inclusive.

16. The method of claim 15 and further comprising mineralizing an amount of PFOA to fluoride ions (F⁻) from 10 to 100 mol %.

17. The method of claim 16 and further comprising mineralizing an amount of PFOA to fluoride ions (F⁻) from 50 to 100 mol %.

18. The method of claim 13, wherein the adsorbed organic compounds include PFOS and thermally treating is performed at a temperature from 400° C. to 1300° C., inclusive.

19. The method of claim 18 and further comprising mineralizing an amount of PFOS to fluoride ions (F⁻) from 10 to 100 mol %.

20. The method of claim 19 further comprising and further comprising mineralizing an amount of PFOS to fluoride ions (F⁻) from 50 to 100 mol %.
